(19) United States
(12) Patent Application Publication
(10) Pub. No.: US 2008/0228814 A1
(43) Pub. Date: Sep. 18, 2008

(54) Determining Software Rationalization for Optimizing Information Handling System Deployments

(76) Inventors: Jefferson Raley, Austin, TX (US); Gregory Bomsta, Austin, TX (US); Kevin Hanes, Round Rock, TX (US); Stephen Oates, Georgetown, TX (US); Kurt Stonecipher, Austin, TX (US)

Correspondence Address: HAMILTON & TERRILE, LLP, P.O. BOX 203518, AUSTIN, TX, 78720, US

(21) Appl. No.: 11/685,403

(22) Filed: Mar. 13, 2007

(51) Int. Cl. G06F 7/00

(52) U.S. Cl. 707/104.1; 707/E17.006

(57) ABSTRACT

An asset discovery tool and process in which information from a customer's hardware and software environment is collected and the resulting customer data is processed using statistical algorithms based upon supplier specific information. After the data is processed, the asset discovery tool use the results to build reports that help customers make decisions regarding their application portfolio which will optimize their information handing system deployment costs.

### CROSS REFERENCE TO RELATED APPLICATION

This application relates to co-pending U.S. patent application Ser. No. ______, attorney docket number DC-12038, filed on an even date herewith, entitled “Client Deployment Optimization Mode,” naming Kevin Hanes, Steven Bodnar, Stephen Oates, Jefferson Raley and Gregory Bomsta as inventors, which is incorporated herein by reference in its entirety.

This application relates to co-pending U.S. patent application Ser. No. ______, attorney docket number DC-12039, filed on an even date herewith, entitled “Method for Information Handling System Deployment Assessment,” naming Kevin Hanes, Gregory Bomsta, Stephen Oates and Jefferson Raley as inventors, which is incorporated herein by reference in its entirety.

This application relates to co-pending U.S. patent application Ser. No. ______, attorney docket number DC-12152, filed on an even date herewith, entitled “Optimized Deployment Solution,” naming Stephen Oates, Kevin Hanes, Marc Jarvis and Jefferson Raley as inventors, which is incorporated herein by reference in its entirety.

### BACKGROUND OF THE INVENTION

1. Field of the Invention

The present invention relates to providing information handling system services and more particularly to determining software rationalization for optimizing information handling system deployments.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity). The large scale information handling system installation provides an information handling system environment.

One issue relating to the service and support of information handling system installation relates to evaluating a customer's portfolio of applications. Managing applications across the enterprise not only represents an operating cost for customers but also contributes significantly to the cost of deploying information handling systems. The cost of deploying information handling systems can in some cases approach or exceed the costs of the information handling systems themselves.

Known application rationalization techniques are generally unique for each customer. Known asset discovery tools provide a number of pre-developed reports.

Known asset discovery tools often focus on managing the applications from the perspective of operating costs rather than from the perspective of optimizing information handling system deployments. One example of a known asset discovery tool is available under the trade designation AssetMetrix from Microsoft Corporation.

To help customers optimize their deployment costs, it is desirable to be able to quickly assess the customer's application portfolio and make recommendations for which applications to consider consolidating, which applications to include in core images, which applications to bundle as part of department or profile loads, and which applications to install separately from the image (and thus which need to be packaged for electronic distribution).

It is desirable to provide an asset discovery tool which provides a set of reports which are directed at optimizing information handling system deployments.

### SUMMARY OF THE INVENTION

In accordance with the present invention, an asset discovery tool and process is set forth in which information from the customer's hardware and software environment is collected and the resulting customer data is processed using statistical algorithms based upon supplier specific information. After the data is processed, the asset discovery tool use the results to build reports that help customers make decisions regarding their application portfolio which will optimize their information handing system deployment costs.

The analytics to determine the results are based upon information derived from providing large numbers (e.g., tens of thousands of information handling systems). Where the providing includes packaging the information handling systems with many applications and managing many different images that are installed onto the information handling systems. The rationalization recommendations for particular customers are stored within database that then enables presentation to new customers of efficiencies (and thus cost savings) associated with previous rationalizations.

The asset discovery tool enables customers to optimize their deployment costs by quickly assessing the customer's application portfolio and making recommendations for which applications to consider consolidating, which applications to include in core images, which applications to bundle as part of department or profile loads, and which applications to install separately from the image (and thus which need to be packaged for electronic distribution).

In one embodiment, the invention relates to a method for optimizing a deployment of information handling systems to a customer. The method includes analyzing a customer information handling system environment to identify applications stored on each information handling system within the information handling system environment, identifying which applications to include within a customer core image and which applications to include in subset loads based upon the analyzing, and generating an optimized deployment recommendation based upon the results of the analyzing and the identifying.

In another embodiment, the invention relates to an apparatus for optimizing a deployment of information handling systems to a customer. The apparatus includes means for analyzing a customer information handling system environment to identify applications stored on each of information handling system within the information handling system environment, means for identifying which applications to include within a customer core image and which applications to include in subset loads based upon the analyzing, and means for generating an optimized deployment recommendation based upon the results of the analyzing and the identifying.

In another embodiment, the invention relates to an information handling system which includes a processor and memory coupled to the processor. The memory stores a module for optimizing a deployment of information handling systems to a customer. The module includes instructions for analyzing a customer information handling system environment to identify applications stored on each of information handling system within the information handling system environment, identifying which applications to include within a customer core image and which applications to include in subset loads based upon the analyzing, and generating an optimized deployment recommendation based upon the results of the analyzing and the identifying.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system on which the deployment and evaluation tool is executed.

FIG. 2 shows a block diagram of a deployment and evaluation tool.

FIG. 3 shows a flow diagram of the operation of the deployment and evaluation tool.

FIG. 4 shows a block diagram of an asset discovery tool.

FIGS. 5A-5F, generally referred to as FIG. 5, show an example screen presentation of a software categorization report of an asset discovery rationalization operation.

FIGS. 6A-6E, generally referred to as FIG. 6, show example screen presentations of a software grouping report of an asset discovery rationalization operation.

### DETAILED DESCRIPTION

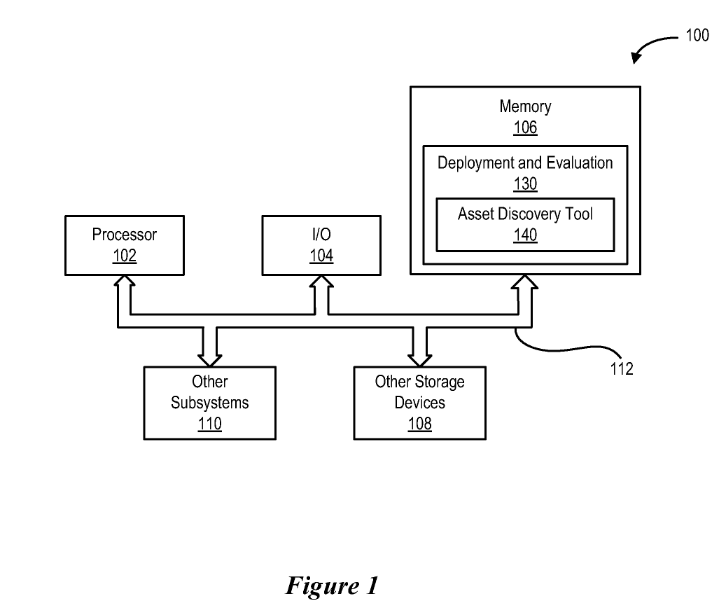

Referring to FIG. 1, a system block diagram of an information handling system 100 on which the deployment and evaluation tool is executed is shown. The information handling system 100 includes a processor 102, input/output (I/O) devices 104, such as a display, a keyboard, a mouse, and associated controllers, a memory 106 including non volatile memory such as a hard disk drive and volatile memory such as random access memory (RAM), and other storage devices 108, such as an optical disk and drive and other memory devices, and various other subsystems 110, all interconnected via one or more buses 112. A deployment and evaluation tool 130 is stored on the memory 106 and executed by the processor 102. The deployment and evaluation tool 130 includes an asset discovery tool 140.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

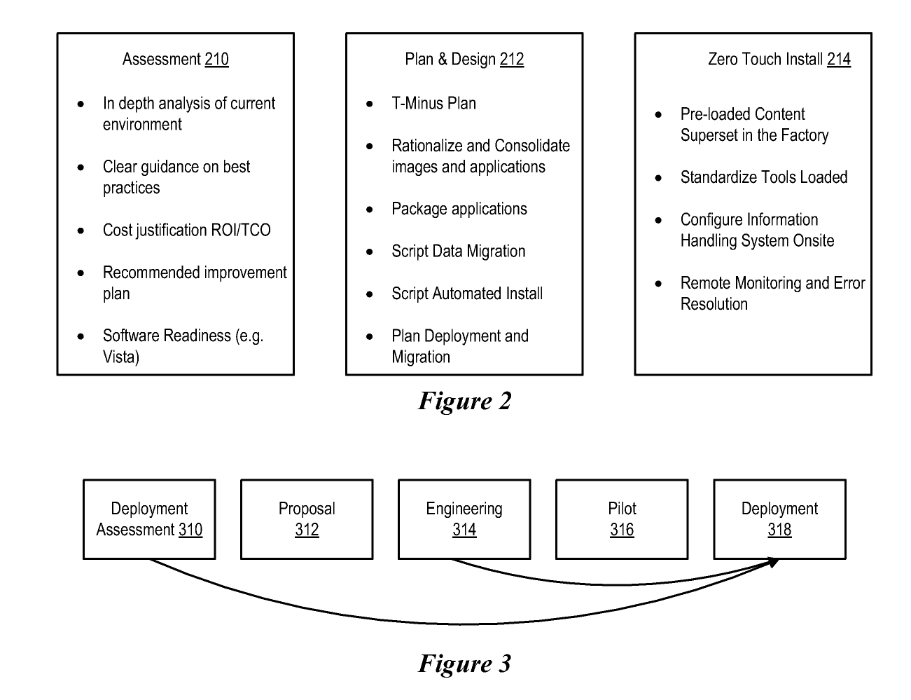

Referring to FIG. 2 a block diagram of the deployment and evaluation tool 130 is shown. More specifically, the deployment and evaluation tool 130 includes an assessment portion 210, a plan & design portion 212 and a zero touch install portion 214.

The assessment portion 210 provides an in depth analysis of a current customer information handling system environment. The assessment portion 210 also provides clear guidance to the customer regarding information handling system environment best practices. The assessment portion 210 also provides support for a deployment cost justification, both with respect to a deployment return on investment (ROI) and a total cost of ownership (TCO). The assessment portion 210 also provides a recommended improvement plan for a customer information handling system environment. The software rationalization may occur entirely independent on assessment portion 210. The assessment portion 210 also determines a software readiness of a current customer information handling system environment. The software readiness can determine, for example, the readiness of a current customer information handling system environment to effectively execute a new operating system such as the Microsoft Vista Operating System.

The plan & design portion 212 develops a recommended readiness (T-Minus) plan. The plan & design portion 212 also rationalizes and consolidates images and applications for install onto information handling systems that are to be deployed. The plan & design portion 212 also packages applications for the information handling systems being deployed. The plan & design portion 212 also develops a script data migration for the information handling systems being deployed. The plan & design portion 212 also develops an automated script install for the information handling systems being deployed. The software rationalization may occur entirely independent of plan & design portion 212. The plan & design portion 212 also develops a plan for the deployment and migration of the information handling system environment.

The zero touch install portion 214 generates a content superset for the content that is to be preloaded onto the information handling system and installs the content superset onto the information handling systems being deployed. The software rationalization may occur entirely independent of zero touch install portion 214. The zero touch install portion 214 also develops and standardizes tools that are loaded onto the information handling system being deployed. The zero touch install portion 214 also enables onsite configuration of the deployed information handling systems. The zero touch install portion 214 also provides for remote monitoring and error resolution of deployed information handling systems.

Referring to FIG. 3, a flow diagram of the operation of the deployment tool 130 is shown. More specifically, the deployment and evaluation tool 130 begins operation by performing a deployment assessment at step 310. The software rationalization may occur entirely independent of evaluation tool 130. A proposal for an information handling system deployment environment is then developed at step 312. Once the proposal is accepted, engineering to develop the information handling system deployment environment is performed at step 314. Next, a pilot of the information handling system deployment environment is deployed at step 316. Next the information handling system deployment environment is deployed at step 318.

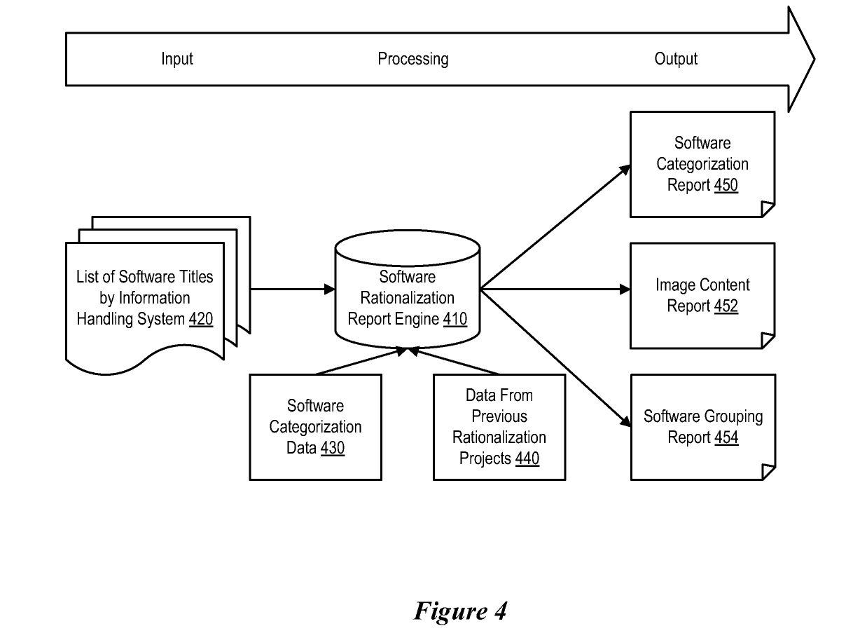

Referring to FIG. 4, a block diagram of an asset discovery tool 140 is shown. More specifically, the asset discovery tool 140 includes a software rationalization report engine 410. The software rationalization report engine 410 receives a list 420 of software titles by information handling system or set of information handling systems. The software rationalization report engine 410 also receives software categorization data 430 as well as data 440 from previous rationalization projects. The software discovery tool will be any one of several commercially available software applications.

The software rationalization report engine 410 generates a plurality of reports including a software categorization report 450, an image content report 452 and a software grouping report 454. The software categorization report 450 provides information regarding categorizing applications by function, as well as identifying applications that are typically not business related. The image content report 452 provides information regarding which applications are common enough to belong in a core system image, or popular enough within a subset of users to belong in a departmental system image. The application grouping report provides information regarding application rationalization by potential subsets (e.g., departments).

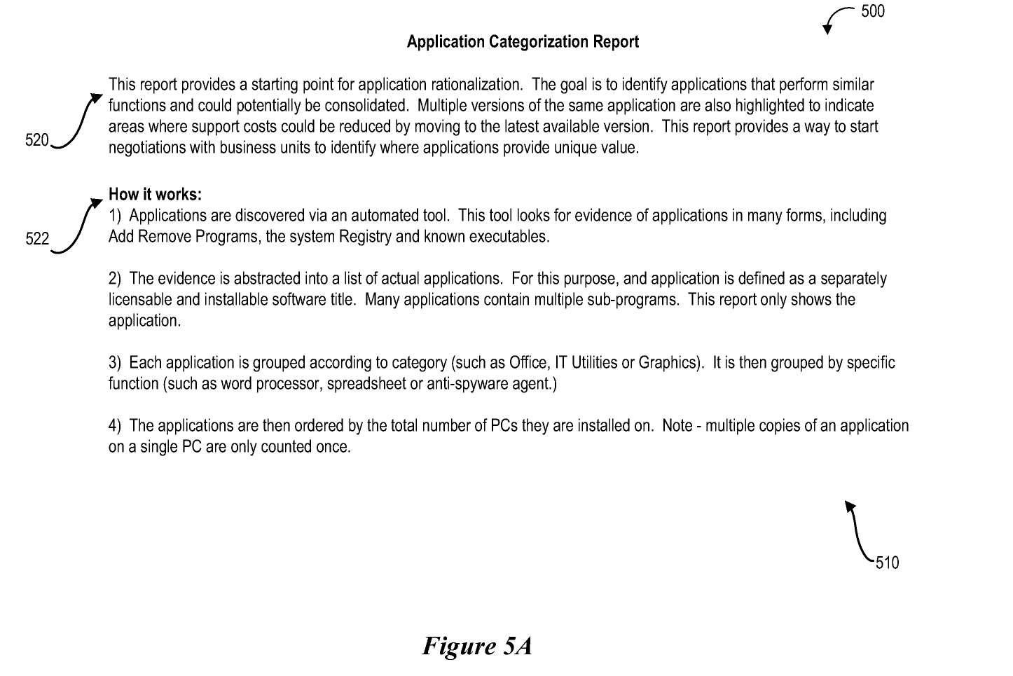

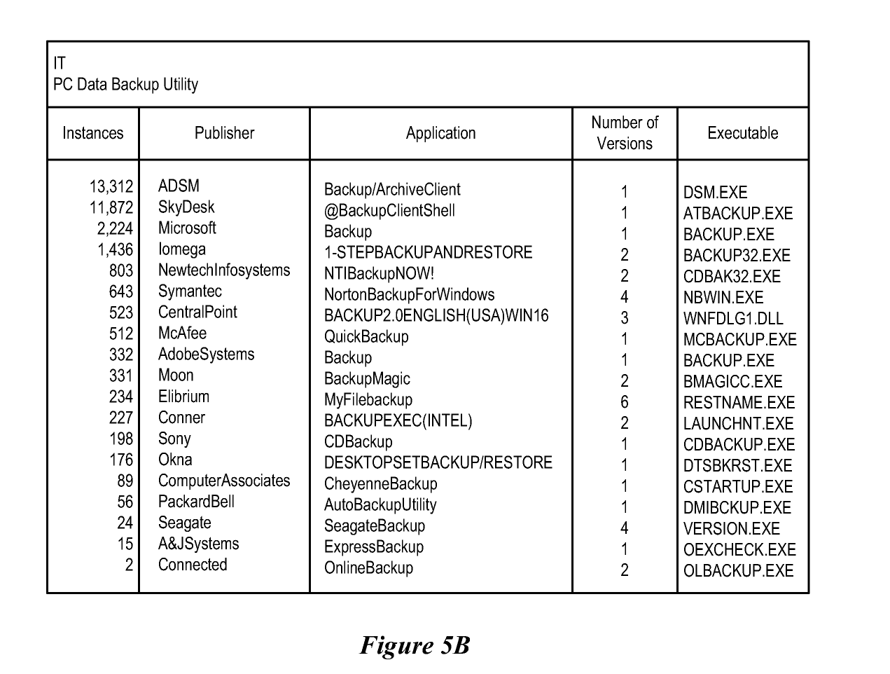

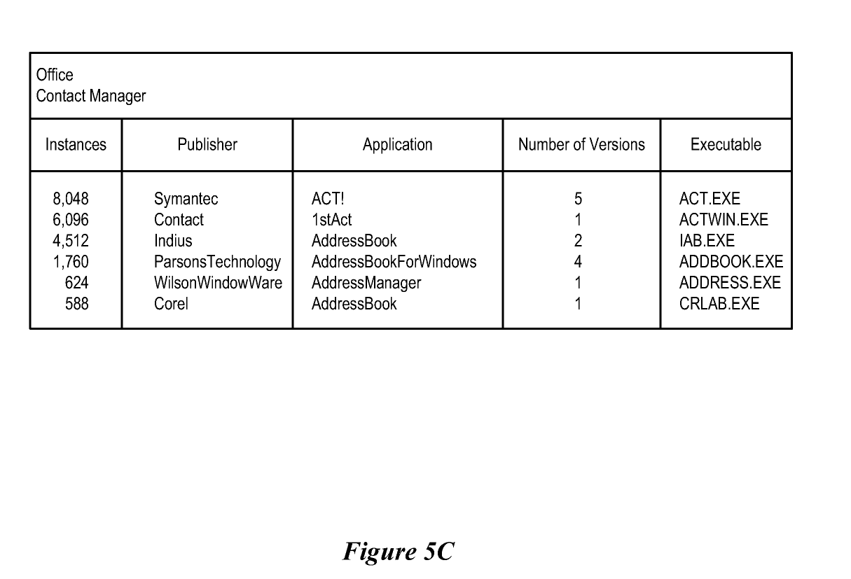

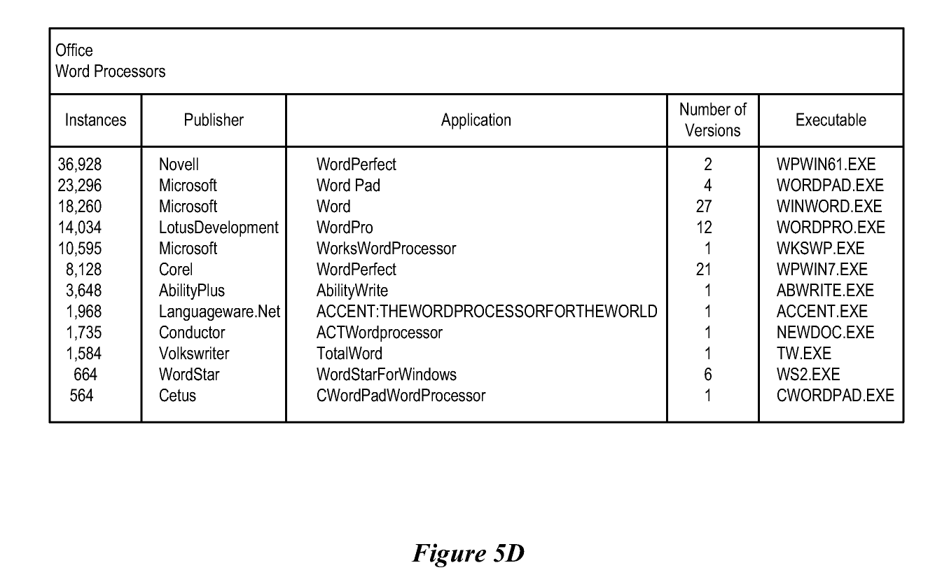

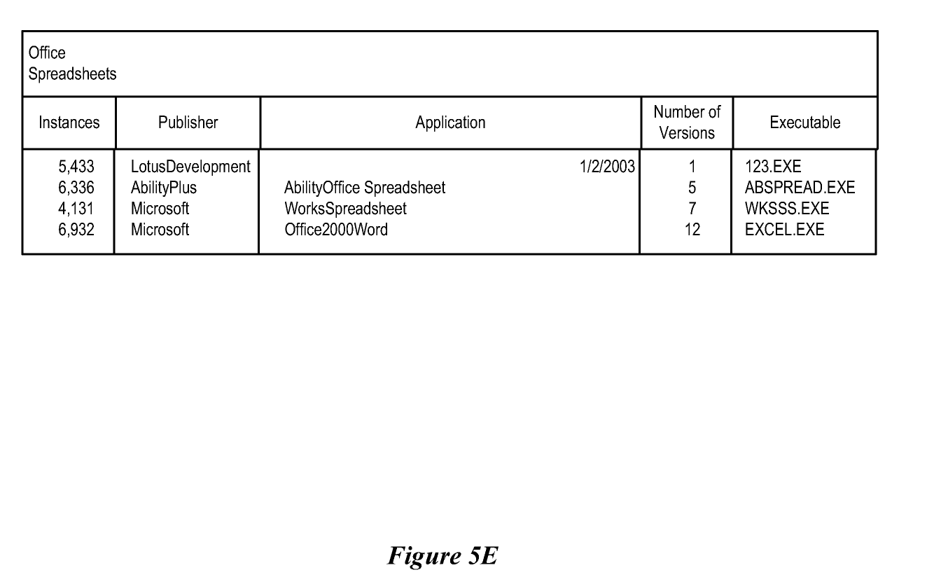

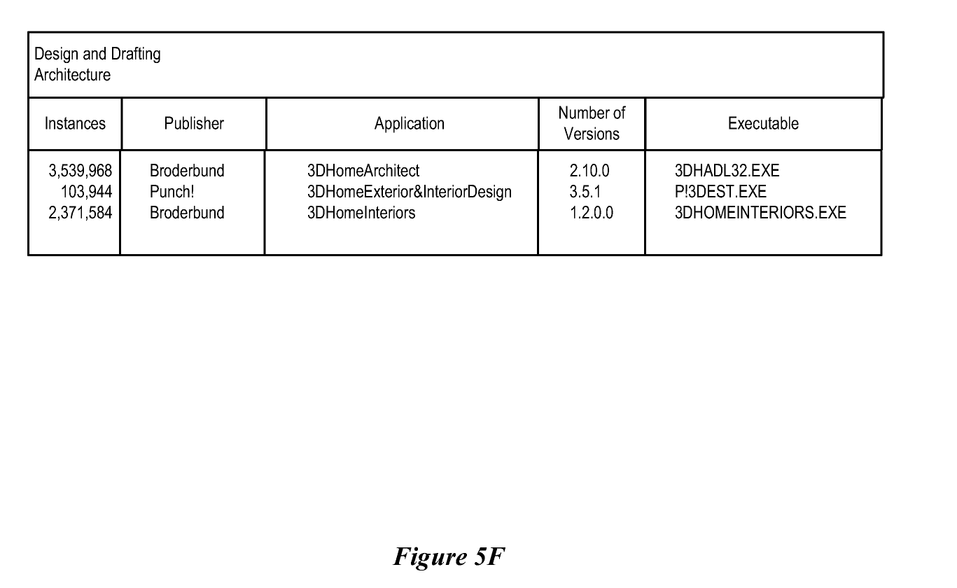

Referring to FIG. 5A-5F, an example screen presentation of a software categorization report 500 of an asset discovery rationalization operation are shown.

The software categorization report 500 provides a starting point for application rationalization. Using the software categorization report 500, it is possible identify applications that perform similar functions and could potentially be consolidated. Multiple versions of the same application are also highlighted within the report to indicate areas where support costs could be reduced by moving to the latest available version.

In operation, applications are discovered via an automated application discovery tool. The application discovery tool searches the various information handling systems for evidence of applications in many forms. The evidence includes Add and Remove Programs information within the operating system of the information handling systems, the information handing system operating system Registry and known executables.

The evidence is abstracted into a list of actual applications. For this purpose, and application is defined as a separately licensable and installable software title. Many applications contain multiple sub-programs. The software categorization report 500 only shows the application. Each application is grouped according to category (such as Office, IT Utilities or Graphics). The information is then grouped by specific function (such as word processor, spreadsheet or anti-spyware agent.) The applications are then ordered by the total number of information handing systems on which the applications are installed. Multiple copies of an application on a single information handling system are only counted once.

More specifically, FIG. 5A shows an example screen presentation of an application categorization report summary 510. FIG. 5B shows an example screen presentation of an application grouping according to category (e.g., a data backup utility category). FIG. 5C shows an example screen presentation of an application grouping according to category (e.g., a contact manager category). FIG. 5D shows an example screen presentation of an application grouping according to category (e.g., a word processor category). FIG. 5E shows an example screen presentation of an application grouping according to category (e.g., a spreadsheet category). FIG. 5F shows an example screen presentation of an application grouping according to category (e.g., a design and drafting category).

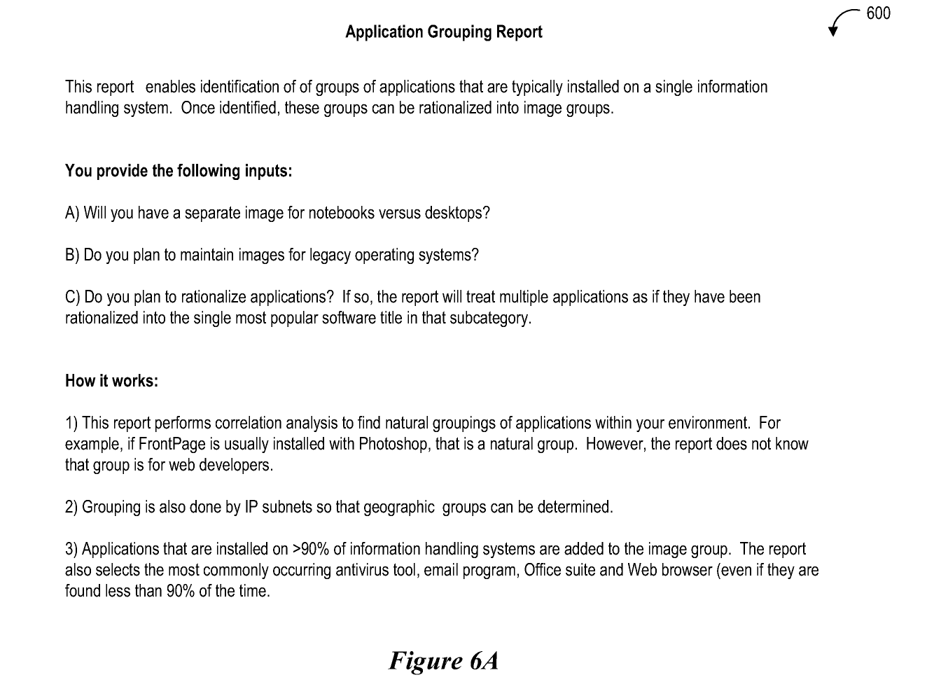

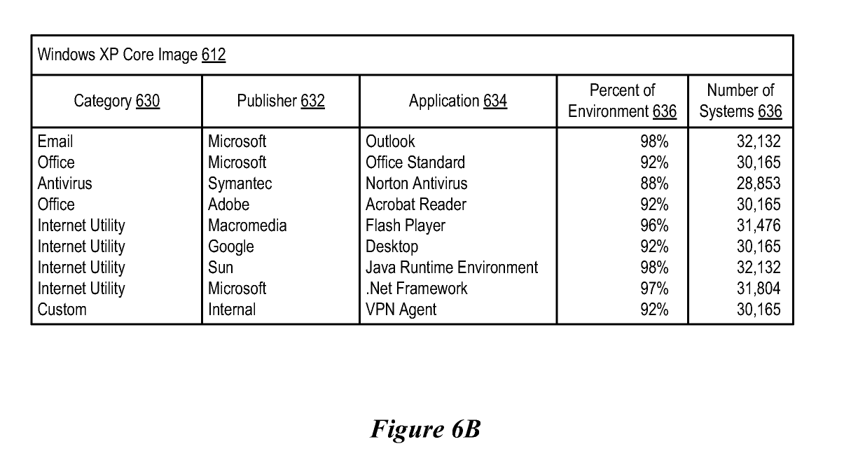

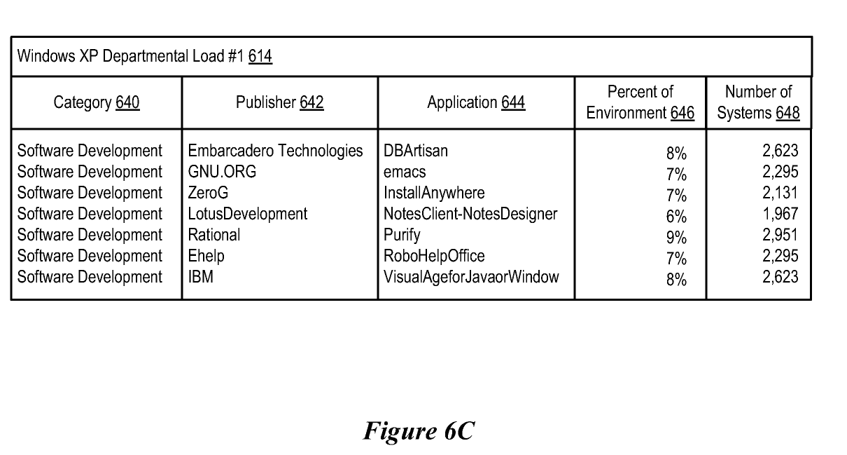

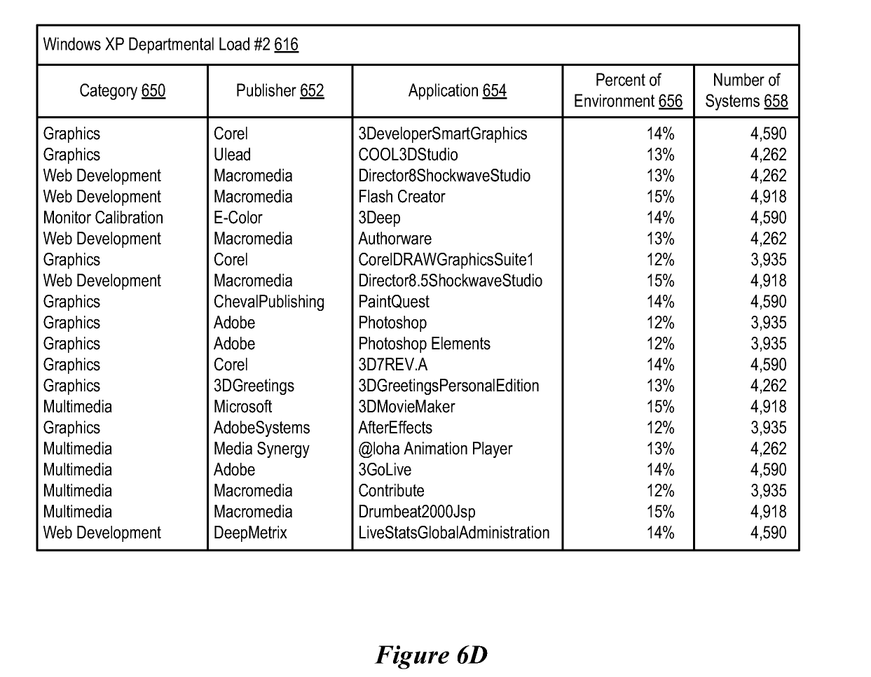

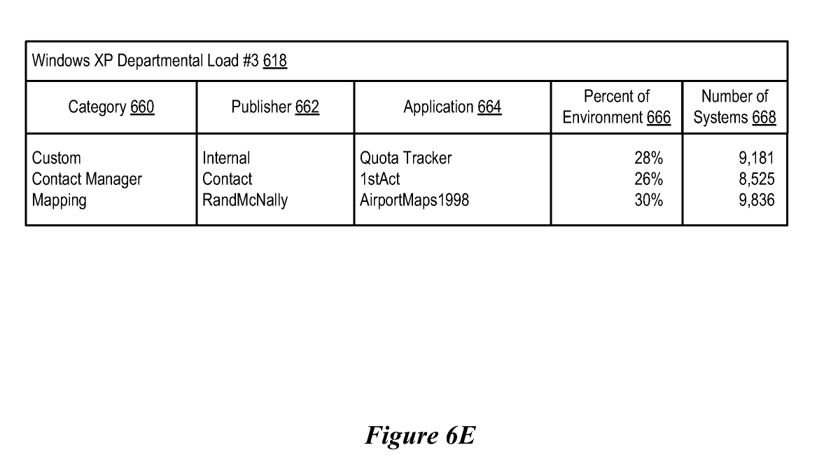

Referring to FIGS. 6A-6E, example screen presentations of a software grouping report 600 of an asset discovery rationalization operation are shown.

The software grouping report 600 enables identification of groups of applications that are typically installed on a single information handling system. Once identified, these groups of applications can be rationalized into image groups.

The software grouping report 600 receives a plurality of inputs including whether a customer will include separate image for notebooks versus desktops, whether a customer plans on maintaining images for legacy operating systems, and whether the customer intends on rationalizing application. If the customer intends on rationalizing applications, the software grouping report treats multiple applications as if they have been rationalized into the single most popular software title in that subcategory.

In operation, the software grouping report 600 performs a correlation analysis to find natural groupings of applications within a customer's environment. For example, if FrontPage is usually installed with Photoshop, that is a natural group. However, the report does not have knowledge of the purpose of the applications grouping. The software grouping report also performs a grouping based upon internet protocol (IP) subnets so that geographic groups can be determined. The software grouping report also determines whether particular applications have been installed on a large percentage (e.g., 0.90%) of the information handling systems. If so, the particular applications are added to an image group. The software grouping report also identifies a most commonly occurring antivirus tool, email program, Office suite and Web browser (even if these applications are found less than the identified percentage of the time.

More specifically, FIG. 6A shows an example screen presentation of an application grouping report summary 610. FIG. 6B shows an example screen presentation of a core image rationalization 612. FIG. 6C shows an example screen presentation of a first subset load rationalization 614. FIG. 6D shows an example screen presentation of a second subset load rationalization 616. FIG. 6E shows an example screen presentation of a third subset load rationalization 618. The subset load rationalizations may be configured according to the functions or organization of a customer for which the rationalization is being performed. For example, if a customer is organized with different departments performing different functions, the subset load rationalizations may be so analyzed.

Referring to FIG. 6A, the application grouping report summary provides information regarding how the rationalization report works based upon particular inputs by the customer.

Referring to FIG. 6B, the core image rationalization report 612 provides rationalization information about a core image, such as an operating system (e.g., the Windows XP operating system) core image. Core image is defined as an exact copy of a computer's hard drive. The copy includes the operating system, drivers and common application software. Images are used to clone a computer's content. The core image rationalization report 612 includes information regarding a category of application 630, a publisher of application 632, an application name 634, a percent of environment indication 636 and a number of systems indication 638. The category of application 630 includes an email category, an office application category, an antivirus category, an internet utility category as well as a customer category. The publisher of application information provides information regarding the publisher of the applications. The application name information 634 provides information regarding the name of the detected applications. The percent of environment indication provides information regarding the percentage of systems having a particular application compared to an overall number of systems present in a customer for which the rationalization operation is being performed. The number of systems indication 638 provides information regarding a total number of systems having a particular application present in a customer for which the rationalization operation is being performed.

FIG. 6C shows an example screen presentation of a first subset load rationalization report 614. The first subset load rationalization report 614 includes information regarding a category of application 640, a publisher of application 642, an application name 644, a percent of environment indication 646 and a number of systems indication 648. The category of application 640 includes a software development category.

FIG. 6D shows an example screen presentation of a second subset load rationalization report 616. The first subset load rationalization report 614 includes information regarding a category of application 650, a publisher of application 652, an application name 654, a percent of environment indication 656 and a number of systems indication 658. The category of application 650 includes a graphics category, a web development category, a monitor calibration category and a multimedia category.

FIG. 6E shows an example screen presentation of a third subset load rationalization. The third subset load rationalization report 618 includes information regarding a category of application 660, a publisher of application 662, an application name 664, a percent of environment indication 666 and a number of systems indication 668. The category of application 660 includes a custom category, a contract manager category and a mapping category.

The categories set forth in the category of application portions of the various screen presentation tend to vary based upon the subset load being rationalized. So for example, in a department that performs a software development function (such as department 1), the categories tend to relate to software development. In a department that performs web or graphics design functions (such as department 2), the categories tend to relate to web and graphics design functions. In a department that performs a sales function (such as department 2), the categories tend to relate to the functions performed by a sales department (e.g., managing contacts and generating directions).

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or DVDs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for optimizing a deployment of information handling systems to a customer comprising
analyzing a customer information handling system environment to identify applications stored on each information handling system within the information handling system environment;
identifying which applications to include within a customer core image and which applications to include in subset loads based upon the analyzing; and,
generating an optimized deployment recommendation based upon the results of the analyzing and the identifying.

2. The method of claim 1, wherein
the core image includes those software applications that apply to a predetermined majority of the information handling systems to be deployed.

3. The method of claim 1, wherein
the subset loads includes those software applications that apply to a predetermined subset of the information handling systems to be deployed.

4. The method of claim 3, wherein
the predetermined subset of the information handling systems to be deployed correspond to departments within an organization of the customer.

5. The method of claim 1, wherein
the analyzing includes comparing the data from the customer with generalized rationalization data, the generalized rationalization data being based upon information derived from rationalization experiences of customers from multiple deployments.

6. An apparatus for optimizing a deployment of information handling systems to a customer comprising
means for analyzing a customer information handling system environment to identify applications stored on each information handling system within the information handling system environment;
means for identifying which applications to include within a customer core image and which applications to include in subset loads based upon the analyzing; and,
means for generating an optimized deployment recommendation based upon the results of the analyzing and the identifying.

7. The apparatus of claim 6, wherein
the core image includes those software applications that apply to a predetermined majority of the information handling systems to be deployed.

8. The apparatus of claim 6, wherein
the subset loads includes those software applications that apply to a predetermined subset of the information handling systems to be deployed.

9. The apparatus of claim 8, wherein
the predetermined subset of the information handling systems to be deployed correspond to departments within an organization of the customer.

10. The apparatus of claim 6, wherein
the means for analyzing includes means for comparing the data from the customer with generalized rationalization data, the generalized rationalization data being based upon information derived from rationalization experiences of customers from multiple deployments.

11. An information handling system comprising:
a processor;
memory coupled to the processor, the memory storing a module for optimizing a deployment of information handling systems to a customer, the module comprising instructions for
analyzing a customer information handling system environment to identify applications stored on each information handling system within the information handling system environment;
identifying which applications to include within a customer core image and which applications to include in subset loads based upon the analyzing; and,
generating an optimized deployment recommendation based upon the results of the analyzing and the identifying.

12. The information handling system of claim 11, wherein
the core image includes those software applications that apply to a predetermined majority of the information handling systems to be deployed.

13. The information handling system of claim 11, wherein
the subset loads includes those software applications that apply to a predetermined subset of the information handling systems to be deployed.

14. The information handling system of claim 13, wherein
the predetermined subset of the information handling systems to be deployed correspond to departments within an organization of the customer.

15. The information handling system of claim 11, wherein the module for optimizing a deployment of information handling systems further comprises instructions for
comparing the data from the customer with generalized rationalization data, the generalized rationalization data being based upon information derived from rationalization experiences of customers from multiple deployments.
